(19) United States
(12) Patent Application Publication
(10) Pub. No.: US 2002/0185164 A1
(43) Pub. Date: Dec. 12, 2002

(54) Apparatus for applying cleaning treatment to the surface of a processed member

(75) Inventors: Takashi Tetsuka, Tokyo (JP); Shigeru Hirao, Tokyo (JP); Syoichi Okano, Tokyo (JP); Tomomi Echigo, Tokyo (JP); Hironobu Suzuki, Tokyo (JP); Masaya Takeuchi, Tokyo (JP); Hirotoshi Inada, Tokyo (JP)

Correspondence Address: Steven I Weisburd, Dickstein Shapiro Morin & Oshinsky LLP, 1177 Avenue of the Americas, 41st Floor, New York, NY, 10036-2714, US

(73) Assignee: NEC CORPORATION, Tokyo (JP)

(21) Appl. No.: 10/096,017

(22) Filed: Mar. 13, 2002

(30) Foreign Application Priority Data
Mar. 15, 2001 (JP) 2001-074094

(51) Int. Cl. B08B 3/02

(52) U.S. Cl. 134/148; 134/902; 134/198; 134/153

(57) ABSTRACT

The cleaning treatment apparatus of the present invention is constituted so that a cleaning liquid is continuously supplied by a liquid film forming means in a gap formed between a surface of a processed member held horizontally and rotationally driven by a holding and rotating means and a ultrasonically oscillating lower face of a ultrasonic oscillating means, to thereby form a liquid film in the gap. Hereby, the surface of the processed member is subjected to a cleaning treatment by the liquid film, which is ultrasonically oscillated by the ultrasonic oscillating means. At this stage, as the processed member is rotated by the holding and rotating means, the surface of the processed member is properly cleaned by the ultrasonically oscillating cleaning liquid not only in a region thereof opposed to the ultrasonic oscillating means during the standstill of the member but also in a region thereof opposed to the ultrasonic oscillating means during the rotation of the member.

### BACKGROUND OF THE INVENTION

1. Field of the Invention

The present invention relates to a cleaning treatment apparatus for applying cleaning treatment to the cut-processed surface of a planar processed member, and to a cutting apparatus provided with the cleaning treatment apparatus and cutting the surface of the planar processed member.

2. Description of the Related Art

Hitherto, in a general method of manufacturing an integrated circuit device, a number of identical integrated circuits are formed on the surface of a single silicon wafer such that the circuits are disposed in a latticed arrangement, and then the wafer is cut by dicing processing into pieces, each having the integrated circuit, to execute the mass production of the integrated circuits.

The execution of the above-described dicing processing naturally produces minute cutting chips of the silicon, and therefore it is usually necessary to apply cleaning treatment to the surface of the silicon wafer that has been subjected to the dicing processing by the use of cleaning liquid such as pure water. In this cleaning treatment, an ordinary cleaning treatment apparatus usually referred to as a spinner cleaning apparatus is used in a manner such that the silicon wafer is usually disposed horizontally to be rotated about a rotating axis, and the cleaning liquid is supplied from above onto the center of the surface of the rotating wafer to achieve the cleaning treatment of the entire surface of the silicon wafer.

Nevertheless, of late years, the integration degree of an integrated circuit has been upgraded accompanied by an advancement of a reduction in the processing size of the circuit. For example, there has been a case where arranging of bonding pads is carried out at a predetermined pitch less than 50 micrometer (μm). Thus, when the arranging pitch between wirings of the integrated circuit is extremely reduced to a minute dimension, cutting chips of which the size is as small as has hitherto caused no problem at all, might cause short-circuiting of the wirings. Therefore, in response to a reduction in the processing dimension of integrated circuits, it is necessary to surely apply cleaning treatment to the integrated circuits in order to remove any minute cutting chips that have produced during the cutting processing.

The various inventions expected to be applied to this type of cleaning treatment are disclosed in, for example, Japanese laid-open Patent Publication No. 9-283487, Japanese Laid-open Utility Model Publication No. 61-188805, Japanese laid-open Patent Publication No. 11-138115, and Japanese laid-open Patent Publication No. 11-138116.

With these prior arts, Japanese Laid-open Patent Publication No. 9-283487 discloses such a technique that when silicon wafers subjected to the dicing processing are transferred, cleaning liquid to which ultrasonic wave is impressed, is showered against the silicon wafers so as to clean them. Further, in the same Publication, it has been also disclosed that the silicon wafers under the cleaning treatment may be either kept in a stationary condition or rotated. Also, the ultrasonic wave might be impressed to the silicon wafers cleaned by the cleaning liquid. Further, it is disclosed that the ultrasonic wave might be impressed to a spinner table on which the silicon wafers cleaned by the cleaning liquid are mounted and supported.

On the other hand, Japanese Laid-open Utility Model Publication No. 61-188805 discloses such a technique that silicon wafers are rotatably supported on an inclined spinner table, and ultrasonic wave is impressed from a ultrasonic oscillator against the surface of the silicon wafers.

However, the prior art disclosed in Japanese Laid-open Patent Publication No. 9-283487 is comprised of a technical constitution in which since the cleaning liquid streaming on the surface of the silicon wafers is subjected the impression of ultrasonic wave, any region in the surface of the silicon wafers, which fails to be covered by the cleaning liquid, could not be sufficiently cleaned. Thus, in the prior art disclosed in this Publication, it is difficult to sufficiently and surely apply cleaning treatment to the whole region of the surface of the silicon wafers by the cleaning liquid that is ultrasonically oscillated. To overcome this difficulty, it might be possible to consider extending the cleaning time and increasing an amount of flow of the cleaning liquid. Nevertheless, the extending of the cleaning time and the increasing of the cleaning liquid amount will result in an increase in the treating time as well as in the treating cost, and accordingly are impractical.

Furthermore, the ultrasonic wave is remarkably attenuated during the transmission thereof in its medium, and therefore, even if the ultrasonic wave is impressed to the cleaning liquid spouted toward the surface of the silicon wafer, the ultrasonic wave is attenuated before it arrives the surface of the silicon wafers through the cleaning liquid. Thus, it becomes difficult to cause appropriate oscillation of the cleaning liquid being in contact with the surface of the silicon wafer, and accordingly the surface of the silicon wafers cannot be well cleaned.

Identically, for the reason that the ultrasonic wave is attenuated during its transmission in the medium, either even if the ultrasonic wave is impressed to the silicon wafers to be subjected to the cleaning treatment, or even if the ultrasonic wave is impressed to the spinner table supporting thereon the silicon wafers to be subjected to the cleaning treatment, it is rather difficult to appropriately ultrasonically oscillate the cleaning liquid being in contact with the silicon wafers, and accordingly the surface of the silicon wafers cannot be well cleaned.

Further, in the prior art disclosed in Japanese Laid-open Utility Model Publication No. 61-188805, since such a particular arrangement that the silicon wafers are supported and rotated on the inclined spinner table is needed, it is difficult to utilize the existing apparatus provided with a spinner table that is constructed so as to horizontally support and to rotate the silicon wafers thereon.

### SUMMARY OF THE INVENTION

An object of the present invention is to provide a cleaning treatment apparatus which is constructed by utilizing an existing apparatus provided with a spinner table that is constructed to horizontally support and to rotate a silicon wafer thereon, so that the cutting-processed surface of a planar processed member may be well subjected to cleaning treatment, and a cutting-processing apparatus provided with the described cleaning treatment apparatus and applying cutting processing to the surface of the planar processed member.

According to an embodiment of the present invention, a cleaning treatment apparatus has such a constitution that a cleaning liquid is continuously supplied by a liquid film forming means in a gap formed between a surface of a processed member held horizontally and rotationally driven by a holding and rotating means and a ultrasonically oscillating lower face of a ultrasonic oscillating means, to produce a liquid film in the gap. The surface of the processed member is subjected to a cleaning treatment by the liquid film, which is ultrasonically oscillated by the ultrasonic oscillating means. At this stage, as the processed member is rotated by the holding and rotating means, the surface of the processed member can be properly cleaned by the ultrasonically oscillating cleaning liquid not only in a region thereof opposed to the ultrasonic oscillating means during the standstill of the member but also in a region thereof opposed to the ultrasonic oscillating means during the rotation of the member.

The apparatus may also have an adjacently disposing means for adjacently disposing said ultrasonic oscillating means at a position above and adjacent to the surface of said processed member in a manner such that the lower face of said ultrasonic oscillating means is held in parallel with the surface of said processed member held by said holding and rotating means. Further, the apparatus may have an oscillation driving means for ultrasonically oscillating said ultrasonic oscillating means.

The holding and rotating means may be constituted so as to rotationally drive said processed member at such a rotating speed that said continuously supplied cleaning liquid generates the liquid film in said gap due to surface tension and is expelled from said gap due to centrifugal force. Hereby, the liquid film, which is generated in the gap between the processed member and the ultrasonic oscillating means is kept there to properly clean the surface of said processed member, and the cleaning liquid after implementing the cleaning operation is expelled from the gap while washing out minute chips which have been removed from the surface of the processed member.

In this case, the rotating speed at which said holding and rotating means rotationally drives said processed member should preferably be kept in a range between 5 and 100 rpm. When the rotating speed of the processed member is equal to or larger than 5 rpm, the supplied cleaning liquid may be expelled from the surface of the processed member by the centrifugal force. When the rotating speed of the processed member is equal to or less than 100 rpm, the supplied cleaning liquid generates a liquid film in the gap between the processed member and the ultrasonic oscillating means by the surface tension.

The said adjacently disposing means may be constituted to dispose said ultrasonic oscillating means at a position adjacent to and above the surface of said processed member in a manner such that a gap having an extension which prevents said ultrasonic oscillating means and said processed member from coming in contact with one another, but permits said cleaning liquid to form, by surface tension, the liquid film between said processed member and said ultrasonic oscillating means, is formed between said ultrasonic oscillating means and said processed member. For example, said gap should preferably be in a range from 0.1 to 5.0 mm. When the gap is equal to or greater than 0.1 mm, the ultrasonic oscillating means, which ultrasonically oscillates, and the rotating processed member do not come into contact with one another. When the gap is equal to or less than 5.0 mm, the liquid film is generated by the continuously supplied cleaning liquid in the gap between the processed member and the ultrasonic oscillating means, due to the surface tension.

An oscillating frequency at which said ultrasonic oscillating means ultrasonically oscillates should preferably range from 0.2 through 3.0 MHz, and more particularly should be in a range of 1.0±0.1 MHz. When the ultrasonic oscillating means oscillates at a frequency within the described frequency range, minute chips are suitably cleaned off from the surface of the processed member by the liquid film of the cleaning liquid, and further no cavitation appears in the liquid film of the cleaning liquid.

Furthermore, the apparatus may be provided with a relatively moving means for relatively moving said processed member and said ultrasonic oscillating means in a horizontal direction. In the cleaning liquid staying around the rotating center of the rotating processed member, bubbles left in the cleaning liquid stagnate. These bubbles greatly attenuate the ultrasonic waves transmitting in the cleaning liquid. However, when the processed member and the ultrasonic oscillating means are relatively moved by the relatively moving means, the bubbles stagnating around the rotating center of the processed member may be dispersed. As a result, attenuation of the ultrasonic wave caused by the bubbles can be prevented. Thus, the surface of the processed member is properly subjected to the cleaning treatment.

The said relatively moving means may be provided with a linear support means for supporting said ultrasonic oscillating means to be linearly freely movable, and a reciprocating means for reciprocating said ultrasonic oscillating means supported by said linear support means. Alternatively, the relatively moving means may be provided with a linear support means for supporting said holding and rotating means to be linearly freely movable, and a reciprocating means for reciprocating said holding and rotating means supported by said linear support means.

The above-mentioned processed member is formed in a disc shape, and said holding and rotating means rotationally drive said processed member in a coaxial condition, and the said ultrasonic oscillating means should preferably have a lower face in the shape of a rectangle having long sides of which the length is either equal to or longer than the diametric dimension of said processed member. Hereby, every portion of the surface of the processed member passes a region located below the ultrasonic oscillating means during the rotation of the processed member, and accordingly the whole region of the surface of the processed member may be subjected to the cleaning treatment.

The adjacently disposing means should preferably be constituted so as to dispose said ultrasonic oscillating means at a position where said ultrasonic oscillating means covers the diametric portion of said processed member.

The liquid film forming means may be constituted so as to continuously supply said cleaning liquid to the outside of both long sides of the lower face of said ultrasonic oscillating means. If the ultrasonic oscillating means having the above-described lower face is arranged at a position located on a diameter of the disc-like processed member, there will appear a dead space that could not be covered by the ultrasonic oscillating means on both outsides of the long sides of the lower face. However, according to the present invention, as the cleaning liquid is supplied to both outsides of the two long sides of the ultrasonic oscillating means, the above-mentioned dead space can be effectively utilized to supply the cleaning liquid to the gap between the ultrasonic oscillating means and the processed member from both outsides of the long sides of the ultrasonic oscillating means.

The liquid film forming means may be constituted so that it is provided with elongated hollow liquid supply members arranged on respective outsides of both long sides of said ultrasonic oscillating means and formed, respectively, with a number of through-holes at the lower face thereof, and a liquid supply system for continuously supplying said cleaning liquid to respective said liquid supply members.

Alternatively, the ultrasonic oscillating means may be formed with through-holes communicating with the lower face of said ultrasonic oscillating means, and the said liquid film forming means may be constituted so as to continuously supply said cleaning liquid to said through-holes. Hereby, the cleaning liquid is directly supplied in the gap between the ultrasonic oscillating means and the processed member, and therefore, during the expelling of the cleaning liquid from the gap toward the outside, chips attached to the surface of the processed member can be washed off by the expelled cleaning liquid.

According to another embodiment of the present invention, the cutting processing apparatus is provided with a cutting-performing unit, the above-mentioned cleaning treatment apparatus, and a member transfer system for transferring said processed member at least from said cutting-performing unit to said cleaning treatment apparatus.

The above and other objects, features and advantages of the present invention will become apparent from the following description with reference to the accompanying drawings, which illustrate examples of the present invention.

### BRIEF DESCRIPTION OF THE DRAWINGS

FIG. 1 is a plan view schematically illustrating an internal construction of a dicing apparatus according to an embodiment of the present invention;

FIG. 2 is a front view schematically illustrating the construction of a cleaning unit of the dicing apparatus according to an embodiment of the present invention;

FIGS. 3A and 3B are perspective views illustrating a positional relationship between a silicon wafer and a ultrasonic oscillator as well as a liquid film forming system which are shown in FIG. 4;

FIG. 4 is a perspective view illustrating the outside of the ultrasonic oscillator of the cleaning unit and the liquid film forming system, shown in FIG. 1;

FIG. 5 is a flow chart illustrating the processing operation carried out by the dicing apparatus shown in FIG. 1;

FIG. 6 is graphical characteristic view illustrating a condition for generating cavitations in the pure water that is a cleaning liquid;

FIG. 7 is a front view schematically illustrating the construction of a modified example of the cleaning unit shown in FIG. 2; and

FIG. 8 is a perspective view illustrating one constitution in which a shaking system that is a relatively moving means is added to the cleaning unit shown in FIG. 2.

### DESCRIPTION OF THE PREFERRED EMBODIMENTS

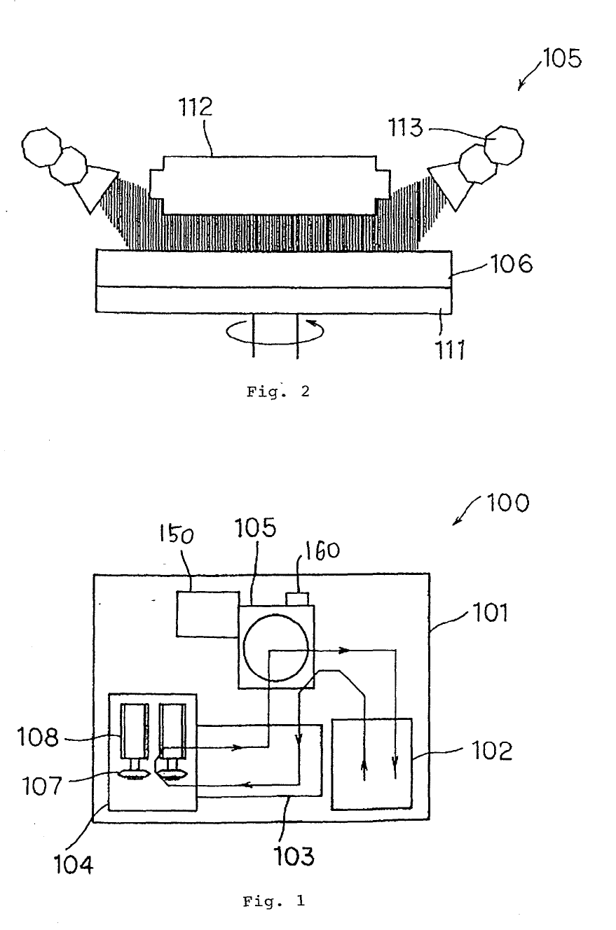

As shown in FIG. 1, dicing apparatus 100 according to an embodiment of the present invention is provided with single machine housing 101 in which elevator unit 102, line unit 103 that is a member transfer system, cutting unit 104 that is a cutting-performing unit, and cleaning unit 105 that is a cleaning treatment apparatus are integrally incorporated.

Elevator unit 102 freely removably accommodates therein a wafer cassette (not shown) on which a number of silicon wafers 106 that are processed members are mounted, and is constituted so as to perform carrying in and out of silicon wafers 106 mounted on the wafer cassette against machine housing 101.

It should be noted that silicon wafers 106 carried in such dicing apparatus 100 are formed in a disc shape, respectively, and the surface of each disc shape silicon wafer 106 is provided with a number of identical integrated circuits (not shown) formed therein in a latticed arrangement.

Line unit 103 is provided with a suction table and a robot arm (both are not shown), and sequentially transfers silicon wafers 106 carried in from elevator unit 102 toward cutting unit 104 and cleaning unit 105. Further, line unit 103 is constituted so as to transfer silicon wafers 106 from cleaning unit 105 to elevator unit 102.

Cutting unit 104 is provided with dicing saw 107 and drive motor 108, and is constituted so as to cut silicon wafers 106 into every integrated circuits by the dicing operation performed by dicing saw 107, which is driven by drive motor 108.

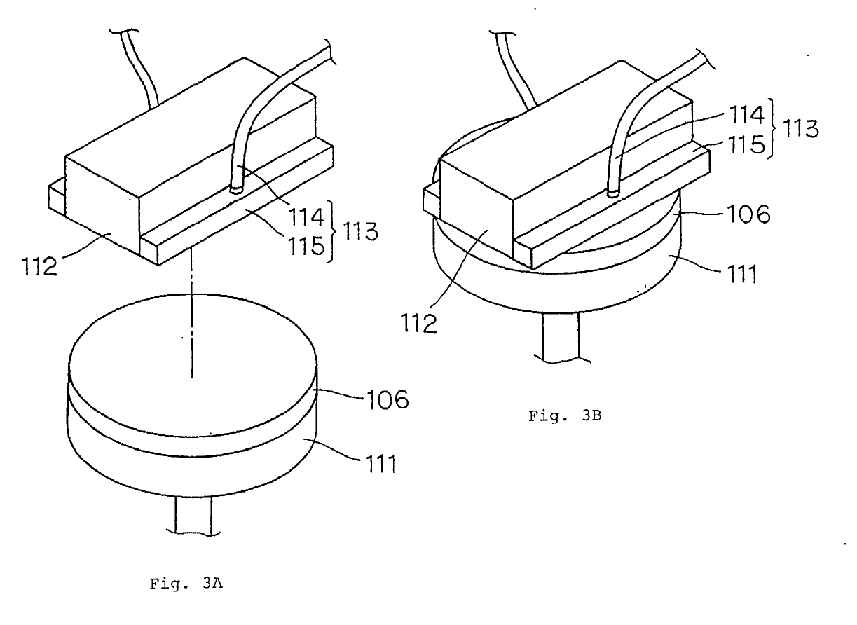

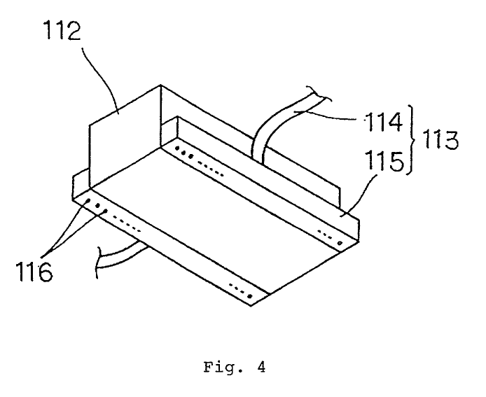

Cleaning unit 105, as shown in FIGS. 2, 3A and 3B, is provided with spinner table 111 that is a holding and rotating means, ultrasonic oscillator 112 that is a ultrasonic oscillating means, and liquid film forming system 113 that is a liquid film forming means. As shown in FIG. 1, cleaning unit 105 is further provided with a movably disposing system 150 that is an adjacently disposing means and operation control circuit 160 that is an oscillation driving means. Hereby, cleaning unit 105 applies a cleaning treatment to the diced flat surfaces of planar silicon wafers 106.

More specifically, spinner table 111 is provided with a suction mechanism and a drive motor (both are not shown), and is constituted so as to horizontally hold silicon wafer 106, which has been transferred from cutting unit 104 by line unit 103, in a condition such that the surface thereof being subjected to the dicing operation is directed upward and to rotationally drive the silicon wafer in a coaxial state. It should here be understood that the “coaxial state” stated above means such a state that the geometric center of the disc-shape silicon wafer 106 coincides with the rotating center of spinner table 111, and there is no eccentricity between both.

The rotational speed of this spinner table 111 may be freely switched from a low-speed rotation for the cleaning operation to a high-speed rotation for the drying purpose operation and vice versa. The rotational speed of the low-speed rotation is set at a 45 rpm in the range between 5 and 100 rpm, and the rotational speed of the high-speed rotation is set at an 800 rpm.

Supersonic oscillator 112 is formed in a parallelepiped shape having a flat and rectangular lower face having at least a pair of sides forming the long sides thereof, each having the length either identical with or longer than the diametric dimension of silicon wafer 106, and the above-mentioned lower face ultrasonically oscillate upon being energized. The oscillating frequency of this ultrasonic oscillator 112 may be set at a value in the range of 0.2 through 3.0 MHz, and is specifically set at 1.0 MHz in the described example.

Movably disposing system 150 is provided with a robot arm and so on, and as shown in FIG. 3A, it brings silicon wafer 106 held by spinner table 111 to a position below and adjacent to ultrasonic oscillator 112. Further, as shown in FIG. 3B, the movably disposing system 150 disposes ultrasonic oscillator 112 over silicon wafer 106. At this moment, movably disposing system 150 positions ultrasonic oscillator 112 relative to silicon wafer 106 so that the lower face of ultrasonic oscillator 112 and the surface of silicon wafer 106 are parallel with each other, and so that a gap provided between the lower face and the surface is 2.6 mm which is within a dimensional range of 0.1 through 5.0 mm.

As shown in FIG. 4, liquid film forming system 113 is provided with a liquid tank (not shown), liquid pump (not shown) corresponding to a liquid supply system, a pair of liquid supply tubes 114, and a pair of liquid supply members 115, and is constituted so as to continuously supply cleaning liquid consisting of pure water to the gap between the adjacently disposed silicon wafer 106 and ultrasonic oscillator 112 thereby forming a liquid film therein. More specifically, as shown in FIG. 4, liquid supply members 115 are formed in an elongated and hollow parallelepiped shape, respectively, and are provided with a number of through-holes 116 in its lower face, respectively. Liquid supply members 115 are attached to the outsides of both long sides of ultrasonic oscillator 112, respectively. The upper faces of these liquid supply members 115 communicating with liquid supply tubes 114 at respective middle positions, and these liquid supply tubes 114 are connected to the liquid tank via the liquid pump.

The liquid tank stores therein cleaning liquid, and when the liquid pump continuously supplies the cleaning liquid to each of liquid supply members 115 via each of liquid supply tubes 114 at a flow rate of 2.0 L/min, the pair of liquid supply members 115 continuously supplies the cleaning liquid to the outsides of both long sides of ultrasonic oscillator 112 via through-holes 116 of the lower faces.

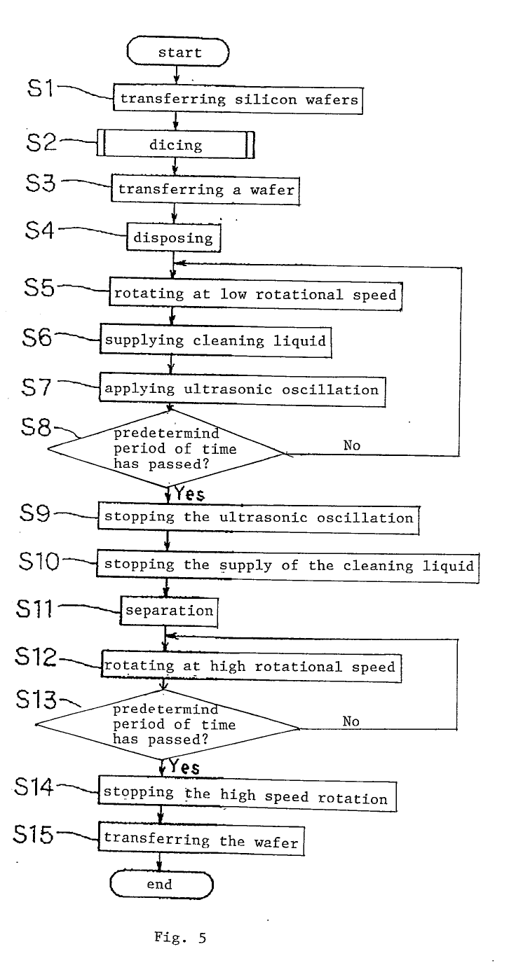

Operation control circuit 160 includes a microcomputer in which an appropriate computer program is installed, and aggregately controls the operations of spinner table 111, ultrasonic oscillator 112, movably disposing system 150 and liquid film forming system 113, in time order, according to the flow chart shown in FIG. 5.

Now, a description of the operation of dicing apparatus 100 having the above-described constitution, according to the present embodiment will be provided hereinbelow with reference to mainly FIG. 5.

Firstly, when a wafer cassette mounting thereon a number of silicon wafers 106 is accommodated in elevator unit 102, such silicon wafers 106 are transferred one by one by line unit 103 toward cutting unit 104 (Step 1), and are subjected to the dicing processing by cutting unit 104 in the processing time of 90 seconds as per each piece of silicon wafer 106 (Step 2).

Since silicon wafer 106 has the surface thereof in which a number of identical integrated circuits are formed in a latticed arrangement, cutting unit 104 cuts silicon wafer 106 so as to apply dicing processing among integrated circuits in a latticed manner. Silicon wafer 106 after completion of the dicing processing is transferred to cleaning unit 105 by line unit 103 (Step 3), and is subjected to cleaning treatment by cleaning unit 105.

More specifically, the cleaning treatment of silicon wafer 106 performed by cleaning unit 105 is carried out in a manner as described in detail hereinbelow.

When silicon wafer 106 is transferred to cleaning unit 105, spinner table 111 holds it in such a state that the surface thereof is directed upward as shown in FIG. 3A. Then, as shown in FIG. 3B, movably disposing system 150 disposes silicon wafer 106 and ultrasonic oscillator 112 so as to form a mutual gap of 2.6 mm therebetween (Step 4).

Subsequently, spinner table 111 rotationally drives silicon wafer 106 at a rotational speed of 45 rpm (Step 5), and liquid film forming system 113 continuously supplies cleaning liquid in the gap between silicon wafer 106 and ultrasonic oscillator 112 at a flow rate of 2.0 L/min (Step 6).

At this time, as the cleaning liquid is continuously supplied to the outsides of both long sides of ultrasonic oscillator 112 through the number of through-holes 116 in the respective lower faces of the elongated hollow liquid supply members 115, the supplied cleaning liquid is approximately equally supplied in the gap between silicon wafer 106 rotating at a low speed and silicon wafer 106, so that liquid film of the cleaning liquid is formed on the surface of silicon wafer 106.

Under this condition, ultrasonic oscillator 112 ultrasonically oscillates the liquid film formed on the surface of silicon wafer 106 at an oscillating frequency of 1.0 MHz (step 7), and thus chips attached to the surface of silicon wafer 106 during the dicing processing are removed by the ultrasonically oscillating liquid film formed by the cleaning liquid being supplied continuously.

When the above-described cleaning treatment lasts for a predetermined period of time of 60 seconds (Step 8), ultrasonic oscillation of ultrasonic oscillator 112 is stopped (Step 9), and further, the supply of cleaning liquid by liquid film forming system 150 is stopped (Step 10). Then, separation of silicon wafer 106 from ultrasonic oscillator 112 to obtain a predetermined distance therebetween is performed by movably disposing system 150 (Step 11).

Subsequently, silicon wafer 106 is rotated at a high-speed for a predetermined period of time by the operation of spinner table 111 (Step 12) so as to dry the surface of silicon wafer 106. The high-speed rotation of silicon wafer 106 continues for a predetermined period of time of 30 seconds, and is then stopped (steps 13 and 14). Thereafter, line unit 103 transfers silicon wafer 106 from cleaning unit 105 to elevator unit 102 (Step 15).

Thus, a series of operations of dicing apparatus 100 is completed.

Although the above description of the series of operations of the dicing apparatus was provided in connection with a single piece of silicon wafer 106, since dicing apparatus 100 according to the present embodiment is constituted so as to be able to implement various kind of operations in parallel, for example, while one silicon wafer 106 is being subjected to the cleaning treatment in cleaning unit 105, another silicon wafer 106 may be subjected to the dicing processing by the operation of cutting unit 104.

In the described dicing apparatus 100 of the present embodiment, the cleaning liquid is continuously supplied in the gap between silicon wafer 106 and ultrasonic oscillator 112 to form the liquid film due to the surface tension between the surface of silicon wafer 106 and the lower face of ultrasonic oscillator 112, and the formed liquid film is ultrasonically oscillated by the operation of ultrasonic oscillator 112 while silicon wafer 106 is being rotationally driven under a horizontally held condition. Thus, the surface of silicon wafer 106 is properly subjected to the cleaning treatment due to the ultrasonically oscillating liquid film. At this stage, since silicon wafer 106 is rotated by spinner table 111, the surface of silicon wafer 106 is surely and appropriately cleaned by the ultrasonically oscillating cleaning liquid not only in its region opposed to ultrasonic oscillator 112 during the standstill but also its region opposed to ultrasonic oscillator 112 during the rotation.

As described above, as the rotating speed of silicon wafer 106 driven by spinner table 111 is set at 45 rpm, it is possible to suitably maintain the liquid film formed by the continuously supplied cleaning liquid in the gap between silicon wafer 106 and ultrasonic oscillator 112 due to the surface tension, and also to expel the cleaning liquid overflowing from the gap from the surface of silicon wafer 106 by centrifugal force.

Further, since the movably disposing system 150 positions ultrasonic oscillator 112 and silicon wafer 106 so that the gap between the lower face of ultrasonic oscillator 112 and the surface of silicon wafer 106 is kept at 2.6 mm, it is possible to prevent ultrasonic oscillator 112 and silicon wafer 106 from coming into contact with each other, and to appropriately maintain the liquid film that the continuously supplied cleaning liquid forms in the gap between silicon wafer 106 and ultrasonic oscillator 112 due to the surface tension.

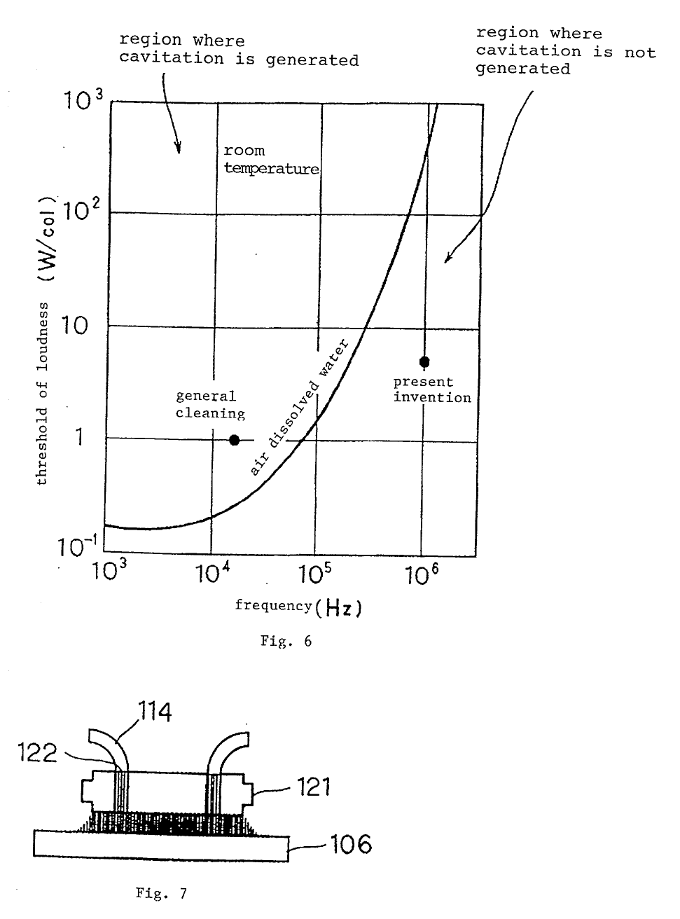

Also, the oscillating frequency of 1.0 MHz at which ultrasonic oscillator 112 oscillates the liquid film of the cleaning liquid allows the minute chips to be properly removed from the surface of silicon wafer 106, and is further able to prevent generation of cavitations in the liquid film of the cleaning liquid consisting of pure water, as shown in FIG. 6.

Further, as described above, ultrasonic oscillator 112 is formed in a parallelepiped shape of which the lower face opposes silicon wafer 106 and has at least a pair of sides that are equal to or greater than the diameter of silicon wafer 106, and as shown in FIG. 3B, ultrasonic oscillator 112 is disposed above the diametric portion of silicon wafer 106 by movably disposing system 150.

When the other pair of sides of ultrasonic oscillator 112 are smaller than the diameter of silicon wafer 106, the whole region of the surface of silicon wafer 106 cannot be covered by ultrasonic oscillator 112, as shown in FIG. 3B. Nevertheless, when at least a pair of sides of the lower face of ultrasonic oscillator 112 opposed to silicon wafer 106 are equal to or greater than the diameter of silicon wafer 106, every portion of the surface of silicon wafer 106 may pass a region covered by ultrasonic oscillator 112 during the rotation of silicon wafer 106, and accordingly the whole region of the surface of silicon wafer 106 can be subjected to the cleaning treatment.

Although when ultrasonic oscillator 112 in the parallelepiped shape is disposed at a position above the diameter of disc-like silicon wafer 106, there appears some dead space on both outsides of the long sides of ultrasonic oscillator 112, which cannot be covered by ultrasonic oscillator 112. However, in dicing apparatus 100 of the present embodiment, since liquid film forming system 113 is constituted so as to continuously supply the cleaning liquid from the respective outsides of the long sides of ultrasonic oscillator 112, effective use of the above-described dead space can be achieved.

Particularly, elongated hollow liquid supply members 115 of liquid film forming system 113 are formed with a number of through-holes 116 at the lower faces thereof, and are arranged on both sides of ultrasonic oscillator 112. Thus, elongated hollow liquid supply members 115 can equally supply the cleaning liquid to a region below ultrasonic oscillator 112 from positions located on the outsides of both long sides of ultrasonic oscillator 112, and as a result, the supplied cleaning liquid can successfully apply the cleaning treatment to the whole region of the surface of silicon wafer 106.

As described hereinbefore, dicing apparatus 100 of the present embodiment performs the dicing processing by cutting unit 104 and the cleaning treatment by cleaning unit 105 in parallel. At this stage, as described before, a time spent for the dicing processing by cutting unit 104 is set 90 seconds, and times spent for the cleaning treatment and drying processing by cleaning unit 105 are set 60 and 30 seconds, respectively. Therefore, the total time period used for the dicing processing by cutting unit 104 is the same as the total time period used for the cleaning and drying processing by cleaning unit 105. Accordingly, any loss of time such that one of the operations performed by respective units 104 and 105 must be ceased for a while before the other of the operations is completely terminated can be prevented from occurring, and the dicing processing and the cleaning treatment can be always carried out in parallel.

It should be appreciated that the present invention is not limited to the constitution of the present embodiment, and a modification may be made without departing from the gist thereof. For example, according to the constitution of the present embodiment, ultrasonic oscillator 112 is formed in a parallelepiped shape and is disposed at a position suitable for covering the diametric portion of silicon wafer 106. Nevertheless, in a modified example, the ultrasonic oscillator may be downsized so that it is disposed at a position suitable for covering only a radial portion of silicon wafer 106. Alternatively, the ultrasonic oscillator may be formed in a disc shape capable of covering the whole region of the surface of silicon wafer 106.

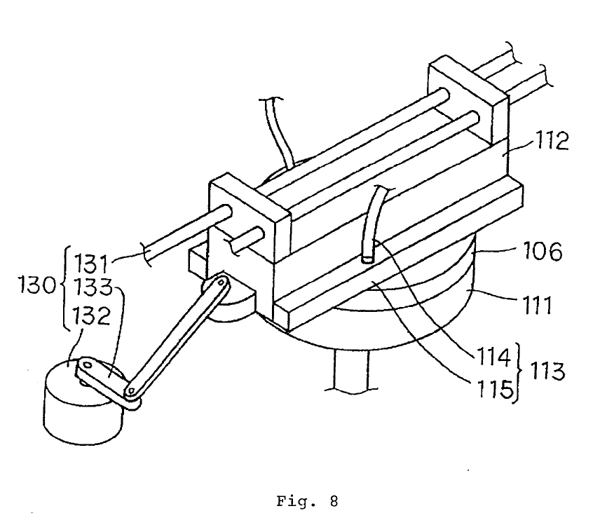

However, when the ultrasonic oscillator is formed in a disc shape capable of covering the whole region of the surface of silicon wafer 106, if the liquid supply members are arranged at the outside of the ultrasonic oscillator, it will be impossible to supply cleaning liquid between the lower face of the ultrasonic oscillator and silicon wafer 106. Thus, in this case, as shown in FIG. 7, ultrasonic oscillator 121 should preferably be formed with through-holes 122 piercing from the upper through the lower faces thereof, to thereby permit the cleaning liquid to be supplied in a gap between ultrasonic oscillator 121 and silicon wafer 106 through the through-holes 122.

Due to such constitution, the cleaning liquid can be directly supplied in the gap between silicon wafer 106 and ultrasonic oscillator 121, and therefore the flow of cleaning liquid expelled from the gap toward the outside will wash off chips attached to the surface of silicon wafer 106 to thereby appropriately apply cleaning treatment to the surface of silicon wafer 106.

Naturally, the ultrasonic oscillator formed in the parallelepiped shape may be formed with the above-mentioned type of through-holes in order to supply the cleaning liquid through the through-holes.

Further, in the present embodiment, when the cleaning treatment is performed, an example is shown in which only a rotational drive is applied to silicon wafer 106, and ultrasonic oscillator 121 performs only ultrasonic oscillation. Nevertheless, the operation that may be performed during the cleaning treatment is not limited to the above-described operations. Namely, in addition to the above-mentioned operations, silicon wafer 106 and ultrasonic oscillator 121 may be mutually relatively moved in a horizontal direction by means of a shaking system 130 (FIG. 8).

The above-mentioned shaking system 130 that is a relatively moving means may be constituted by, e.g., as shown in FIG. 8, horizontal guide rails 131 that is a linear support means for freely slidably supporting ultrasonic oscillator 112, link mechanism 133 connected to ultrasonic oscillator 112, and drive motor 132. Link mechanism 133 and drive motor 132 form a reciprocating means for reciprocating ultrasonic oscillator 112 through driving of link mechanism 133 by drive motor 132. Due to shaking system 130 having such constitution, ultrasonic oscillator 112 is supported by horizontal guide rails 131 to be freely moved along these guide rails 131, and thus may shake along guide rails 131 through the reciprocative movement thereof given by link mechanism 133 connected to ultrasonic oscillator 112 and driven by drive motor 132.

Bubbles remaining in the cleaning liquid are still held in the cleaning liquid that is left in a region about the rotating center of silicon wafer 106 under rotation. These bubbles might greatly attenuate the ultrasonic wave transmitting in the cleaning liquid. However, when shaking system 130 provides silicon wafer 106 and ultrasonic oscillator 112 with a mutual relative movement in a horizontal direction, the bubbles left in the region about the rotating center of silicon wafer 106 under rotation can be dispersed therefrom. Thus, attenuation of the ultrasonic wave by the bubbles can be prevented, and the cleaning treatment applied to the surface of silicon wafer 106 can be successfully achieved.

It should be noted that the shaking system provided with the above-described constitution could reciprocate not only ultrasonic oscillator 112 but also spinner table 111. For example, if two shaking systems are preliminarily arranged, one of them might be used for reciprocative move ultrasonic oscillator 112 in a back-and-forth direction, and the other might simultaneously be used for reciprocative move in a left-and-right direction orthogonal with the above-mentioned back-and-forth direction.

In the foregoing description, although various concrete numerical values such as the frequency of ultrasonic oscillator 112, 121 were exampled, it should be understood that these numerical values might be adjusted within the described numerical range, respectively. Nevertheless, it should also understood that the adjustment of the exampled numerical values should preferably be made by taking into consideration the relative relationship among the associated numerical values.

In the described present embodiment, a case was exampled where the various numerical values are fixedly set during the processing of the cleaning treatment. However, these numerical values might be changed during the processing of the cleaning treatment. For example, the gap between silicon wafer 106 and ultrasonic oscillator 112, 121 may be changed within the range of 0.1 through 5.0 mm during the processing of the cleaning treatment, and also the rotating speed of silicon wafer 106 may be changed within the range of 5 through 100 rpm. Further, the frequency of ultrasonic oscillator 112, 121 may be changed within the range of 0.2 through 3.0 MHz, and also the flow rate of liquid film forming system 113 may be adjustably changed.

Furthermore, in the described embodiment, although utilization of pure water was exampled to be used as the cleaning liquid, the use for the cleaning liquid should not be limited to the pure water. Any other liquid medium may be used as a cleaning liquid, if it did not generate any residue when being dried, and if it were able to clean without corroding the integrated circuits on silicon wafer 106. Thus, for example, a liquid consisting of pure water containing therein surfactant, alcohol, ammonia, and the like might be employed.

Further, in the described embodiment, although the processed member, which is subjected to the cutting processing through the cleaning treatment performed by dicing apparatus 100 is exampled by silicon wafer 106, the application of dicing apparatus 100 is not limited to silicon wafer but is applied to many other processed members. Dicing apparatus 100 of the present embodiment may be applied to various semiconductor wafers other than silicon wafer 106, and planar members such as printed circuit boards on which integrated circuits are mounted and sealed by resin while acquiring good results similar to those obtained with regard to the above-described example of silicon wafer 106.

In the described dicing apparatus 100 of the present embodiment, although cleaning unit 105 is exampled to be integrally incorporated therein, such cleaning unit might be constructed as an independent cleaning apparatus, and then might be either incorporated in or externally connected to an existing dicing apparatus as required.

In the present embodiment, a case is exampled wherein the rotationally driving of silicon wafer 106 by spinner table 111, the supply of cleaning liquid by liquid film forming system 113, and ultrasonic oscillation of the liquid film by ultrasonic oscillator 112 are sequentially put into operation in that order and stopped in the reverse order. Nevertheless, the order of starting and stopping of the respective operations might be changed, and further might be simultaneous.

For example, in the present embodiment, after the start of low-speed rotation of silicon wafer 106 (Step 5), the supply of cleaning liquid is started (Step 6). However, when drying of cleaning liquid should be prevented, the above-mentioned steps 5 and 6 may be changed from one another.

While preferred embodiments of the present invention have been described using specific terms, such description is for illustrative purpose only, and it is to be understood that changes and variations may be made without departing from the spirit or scope of the following claims.

What is claimed is:

1. A cleaning treatment apparatus for applying cleaning treatment to a cut-processed surface of a planar processed member, comprising:
a holding and rotating means for horizontally holding the planar processed member in a state where the cut-processed surface of said processed member is directed upward and for rotationally driving said planar processed member;
a ultrasonic oscillating means arranged to be opposed to said processed member and provided with at least a flat lower face ultrasonically oscillating; and
a liquid film forming means for continuously supplying cleaning liquid in a gap between said processed member and said ultrasonic oscillating means to thereby form a liquid film.

2. The cleaning treatment apparatus according to claim 1, further comprising an adjacently disposing means for adjacently disposing said ultrasonic oscillating means at a position above and adjacent to the surface of said processed member in a manner such that the lower face of said ultrasonic oscillating means is held in parallel with the surface of said processed member held by said holding and rotating means.

3. The cleaning treatment apparatus according to claim 1, further comprising an oscillation driving means for ultrasonically driving said ultrasonic oscillating means.

4. The cleaning treatment apparatus according to claim 1, wherein said holding and rotating means rotationally drives said processed member at a rotating speed that said continuously supplied cleaning liquid generates the liquid film in said gap due to surface tension and is expelled from said gap due to centrifugal force.

5. The cleaning treatment apparatus according to claim 4, wherein a rotating speed at which said holding and rotating means rotationally drives said processed member is kept in a range of 5 through 100 rpm.

6. The cleaning treatment apparatus according to claim 2, wherein said adjacently disposing means disposes said ultrasonic oscillating means at a position adjacent to and above the surface of said processed member in a manner such that a gap having an extension which prevents said ultrasonic oscillating means and said processed member from coming in contact with each other while permitting said cleaning liquid to form, by surface tension, the liquid film between said processed member and said ultrasonic oscillating means, is formed between said ultrasonic oscillating means and said processed member.

7. The cleaning treatment apparatus according to claim 6, wherein said gap is in a range from 0.1 to 5.0 mm.

8. The cleaning treatment apparatus according to claim 1, wherein an oscillating frequency at which said ultrasonic oscillating means ultrasonically oscillates is in a range from 0.2 through 3.0 MHz.

9. The cleaning treatment apparatus according to claim 8, wherein the oscillating frequency at which said ultrasonic oscillating means ultrasonically oscillates is in a range of 1.0±0.1 MHz.

10. The cleaning treatment apparatus according to claim 1, further comprising a relatively moving means for relatively moving said processed member and said ultrasonic oscillating means in a horizontal direction.

11. The cleaning treatment apparatus according to claim 10, wherein said relatively moving means comprises:
a linear support means for supporting said ultrasonic oscillating means to be linearly freely movable; and
a reciprocating means for reciprocating said ultrasonic oscillating means supported by said linear support means.

12. The cleaning treatment apparatus according to claim 10, wherein said relatively moving means comprising:
a linear support means for supporting said holding and rotating means to be linearly freely movable; and
a reciprocating means for reciprocating said holding and rotating means supported by said linear support means.

13. The cleaning treatment apparatus according to claim 1, wherein
said processed member is formed in a disc shape,
said holding and rotating means rotationally drives said processed member in a coaxial condition, and
said ultrasonic oscillating means has a lower face in the shape of a rectangle having long sides of which the length is either equal to or longer than the diameter of said processed member.

14. The cleaning treatment apparatus according to claim 13, further comprising an adjacently disposing means for adjacently disposing said ultrasonic oscillating means at a position above and adjacent to the surface of said processed member in a manner such that the lower face of said ultrasonic oscillating means is held in parallel with the surface of said processed member held by said holding and rotating means, wherein said adjacently disposing means disposes said ultrasonic oscillating means at a position where said ultrasonic oscillating means covers a diametric portion of said processed member.

15. The cleaning treatment apparatus according to claim 13, wherein said liquid film forming means continuously supplies said cleaning liquid to the outside of both long sides of the lower face of said ultrasonic oscillating means.

16. The cleaning treatment apparatus according to claim 15, wherein said liquid film forming means comprises:
elongated hollow liquid supply members arranged on respective outsides of both long sides of said ultrasonic oscillating means and formed, respectively, with a number of through-holes at the lower face thereof; and
a liquid supply system for continuously supplying said cleaning liquid to respective said liquid supply members.

17. The cleaning treatment apparatus according to claim 1, wherein said ultrasonic oscillating means is formed with through-holes communicating with the lower face of said ultrasonic oscillating means, and wherein said liquid film forming means continuously supplies said cleaning liquid to said through-holes.

18. A cutting processing apparatus comprising:
a cutting performing unit for applying a cutting processing to a surface of a planar processed member;
said cleaning treatment apparatus according to claim 1; and
a member transfer system for transferring said processed member at least from said cutting performing unit to said cleaning treatment apparatus.
